(19) United States
(12) Patent Application Publication
(10) Pub. No.: US 2014/0025907 A1
(43) Pub. Date: Jan. 23, 2014

(54) STORAGE CONTROL APPARATUS, STORAGE APPARATUS, AND PROCESSING METHODS THEREOF

(71) Applicant: SONY CORPORATION, TOKYO (JP)

(72) Inventors: Yasushi Fujinami, Tokyo (JP); Naohiro Adachi, Tokyo (JP); Ken Ishii, Tokyo (JP); Hideaki Okubo, Saitama (JP); Keiichi Tsutsui, Kanagawa (JP); Kenichi Nakanishi, Tokyo (JP); Tatsuo Shinbashi, Tokyo (JP)

(21) Appl. No.: 13/906,378

(22) Filed: May 31, 2013

(30) Foreign Application Priority Data
Jul. 18, 2012 (JP) 2012-159688

(51) Int. Cl. G06F 3/06

(52) U.S. Cl. CPC G06F 3/0619; G06F 3/0653; G06F 3/0679
USPC 711/156

(57) ABSTRACT

There is provided a storage control apparatus including a memory state acquisition unit acquiring a storage state of a memory associated with a write target, and an operation instruction generation unit generating an operation instruction of at least 2 bits per cell of the memory associated with the write target, from the acquired storage state and write data.

### BACKGROUND

The present disclosure relates to a storage control apparatus. Specifically, the present disclosure relates to a storage control apparatus, storage apparatus, and information processing system for a nonvolatile memory, processing methods thereof, and a program to cause a computer to perform the processing methods.

In an information processing system, for example, a DRAM (Dynamic Random Access Memory) is used as a work memory. This DRAM is normally a volatile memory and loses storage content at the time a power supply stops. Meanwhile, recently, a nonvolatile memory (NVM) is used. This nonvolatile memory is broadly classified into a flash memory supporting data access with a large size unit and a nonvolatile random access memory (NVRAM) that enables high-speed random access with a small unit. Here, as a representative example of the flash memory, there is provided a NAND-type flash memory. Meanwhile, as an example of the nonvolatile random access memory, there are provided a ReRAM (Resistance RAM), a PCRAM (Phase-Change RAM), a MRAM (Magnetoresistive RAM) and so on.

In a general memory system in the related art, an information amount in a writing instruction with respect to a memory is one bit per bit written in the memory, and a memory cell state after the writing operation is the alternative of 0 or 1 (e.g. see Kuwano Masahiko, “Practical Use of Memory IC,” CQ Publishing Company, September 2001, pages 54, 100, 120 and 191). This shows that, for example, in a write command with respect to a DRAM, a data bus is latched in a state where a write enable terminal is asserted, and latched data is written in a designated address.

### SUMMARY

In the above related art, since an instruction information amount per memory bit is one bit, information that can be given from the outside of the memory is limited. Meanwhile, in a memory system using a nonvolatile random access memory such as a ReRAM and a PCRAM, an error correction function of high efficiency is often used together. Since such an error correction function of high efficiency requests a large hardware scale, there are many cases where it is placed on, for example, a chip outside a memory, which is called “memory controller.” Also, in such a memory system, although it may perform adaptive control using error position information that can be known by the error correction function, it is difficult to perform the adaptive control because of the limitations of an interface function in a general memory in the related art.

The present disclosure is made in view of the above state and enables adaptive control by setting an instruction information amount per memory bit to multiple bits.

According to a first embodiment of the present technology, there is provided a storage control apparatus or a control method of the same, the storage control apparatus including a memory state acquisition unit acquiring a storage state of a memory associated with a write target, and an operation instruction generation unit generating an operation instruction of at least 2 bits per cell of the memory associated with the write target, from the acquired storage state and write data. By this means, there is provided an effect of performing adaptive control according to a storage state of a memory associated with a write target.

According to the first embodiment of the present technology, the memory state acquisition unit may include a read processing unit reading out data stored in the memory associated with the write target, as read data, and an error detection unit performing an error detection of the read data and generating error position information indicating a position in which an error is detected. The memory state acquisition unit may acquire the read data and the error position information as the storage state. By this means, there is provided an effect of performing adaptive control according to read data and error position information.

According to the first embodiment of the present technology, the operation instruction may include an instruction related to a combination of a polarity and intensity of writing in the memory associated with the write target. By this means, there is provided an effect of controlling a combination of the polarity and intensity of writing according to a storage state of a memory associated with a write target.

In the above case and in a case where the memory is a variable resistive element, the polarity of the writing may be in one of a high resistive state and a low resistive state, which are decided by a predetermined threshold value in the variable resistive element, and the intensity of the writing may be an intensity of a resistive state in the variable resistive element.

According to the first embodiment of the present technology, the operation instruction may include an instruction related to two writings of different polarities in the memory associated with the write target. By this means, there is provided an effect of avoiding the same polarity from being continuously written.

According to the first embodiment of the present technology, the operation instruction generation unit may encode the operation instruction by a variable-length code. By this means, there is provided an effect of reducing the operation instruction size.

According to a second embodiment of the present technology, there is provided a storage apparatus including a memory including a plurality of memory cells, an operation instruction acquisition unit acquiring an operation instruction of at least 2 bits per cell of the memory cell associated with a write target, and a control unit performing write processing on the memory cell associated with the write target according to the operation instruction. By this means, there is provided an effect of receiving adaptive control according to a storage state of a memory cell associated with a write target.

According to a third embodiment of the present technology, there is provided a storage apparatus including a memory including a plurality of memory cells, a memory state acquisition unit acquiring a storage state of the memory cell associated with a write target, an operation instruction generation unit generating an operation instruction of at least 2 bits per cell of the memory cell associated with the write target, from the acquired storage state and write data, and a control unit performing write processing on the memory cell associated with the write target according to the operation instruction. Also, according to a third embodiment of the present disclosure, there is provided a storage apparatus including: a memory including a plurality of memory cells; a memory state acquisition unit acquiring a storage state of the memory cell associated with a write target; an operation instruction generation unit generating an operation instruction of at least 2 bits per cell of the memory cell associated with the write target, from the acquired storage state and write data; and a control unit performing write processing on the memory cell associated with the write target according to the operation instruction. By this means, there is provided an effect of performing adaptive control according to a storage state of a memory cell associated with a write target.

According to the embodiments of the present disclosure, it is possible to provide a beneficial effect of enabling adaptive control by setting an instruction information amount per memory bit to multiple bits.

### BRIEF DESCRIPTION OF THE DRAWINGS

FIG. 1 is a diagram illustrating a configuration example of an information processing system according to an embodiment of the present disclosure;

FIG. 2 is a diagram illustrating a management example of logical pages according to an embodiment of the present disclosure;

FIG. 3 is a diagram illustrating a management example of a physical page according to an embodiment of the present disclosure;

FIG. 4 is a diagram illustrating a function configuration example of a storage control apparatus 200 according to an embodiment of the present disclosure;

FIG. 5 is a diagram illustrating a configuration example of a memory 100 according to an embodiment of the present disclosure;

FIG. 6 is a diagram illustrating an example of a configuration of a memory cell array 110 according to an embodiment of the present disclosure;

FIG. 7 is a diagram for explaining a drive voltage of the memory cell array 110 according to an embodiment of the present disclosure;

FIG. 8 is a diagram for explaining the polarity and intensity of a resistive state of the memory cell array 110 according to an embodiment of the present disclosure;

FIG. 9 is a diagram illustrating a relationship example of read data, write data, error position information and processing content in the memory 100 according to the first embodiment of the present disclosure;

FIG. 10 is a diagram illustrating an example of operation instruction numbers according to the first embodiment of the present disclosure;

FIG. 11 is a diagram illustrating an example of a memory operation instruction pattern according to the first embodiment of the present disclosure;

FIG. 12 is a diagram illustrating a cell pattern type example according to the first embodiment of the present disclosure;

FIG. 13 is a diagram illustrating a specific example of cell patterns according to the first embodiment of the present disclosure;

FIG. 14 is a flowchart illustrating a processing procedure example of operations with respect to a write command of a storage control apparatus 200 according to an embodiment of the present disclosure;

FIG. 15 is a flowchart illustrating a processing procedure example of operations with respect to a read request of a memory 100 according to an embodiment of the present disclosure;

FIG. 16 is a flowchart illustrating a processing procedure example of operations with respect to a write request of the memory 100 according to an embodiment of the present disclosure;

FIG. 17 is a flowchart illustrating a processing procedure example of a set operation of the memory 100 according to an embodiment of the present disclosure;

FIG. 18 is a flowchart illustrating a processing procedure example of a strong set operation of the memory 100 according to an embodiment of the present disclosure;

FIG. 19 is a flowchart illustrating a processing procedure example of a reset operation of the memory 100 according to an embodiment of the present disclosure;

FIG. 20 is a flowchart illustrating a processing procedure example of a strong reset operation (step S970) of the memory 100 according to an embodiment of the present disclosure;

FIG. 21 is a diagram illustrating an assignment example of operation instruction numbers according to the second embodiment of the present disclosure;

FIG. 22 is a diagram illustrating a definition example using virtual language expression of operation instruction numbers according to the second embodiment of the present disclosure;

FIG. 23 is a diagram illustrating an assignment example of operation instruction numbers according to the third embodiment of the present disclosure;

FIG. 24 is a diagram illustrating a definition example using virtual language expression of operation instruction numbers according to the third embodiment of the present disclosure;

FIG. 25 is a diagram illustrating a relationship example of read data, write data, error position information and processing content in the memory 100 according to the fourth embodiment of the present disclosure; and

FIG. 26 is a diagram illustrating an example of operation instruction numbers according to the fourth embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the following, embodiments of the present disclosure (hereinafter referred to as “embodiments”) are explained. An explanation is given in the following order.

1. First embodiment (example assuming strong writing)

2. Second embodiment (example using variable-length code as memory operation instruction pattern)

3. Third embodiment (example assuming strong writing and weak writing)

4. Fourth embodiment (example assuming double operations)

### 1. First Embodiment

### [Configuration of Information Processing System]

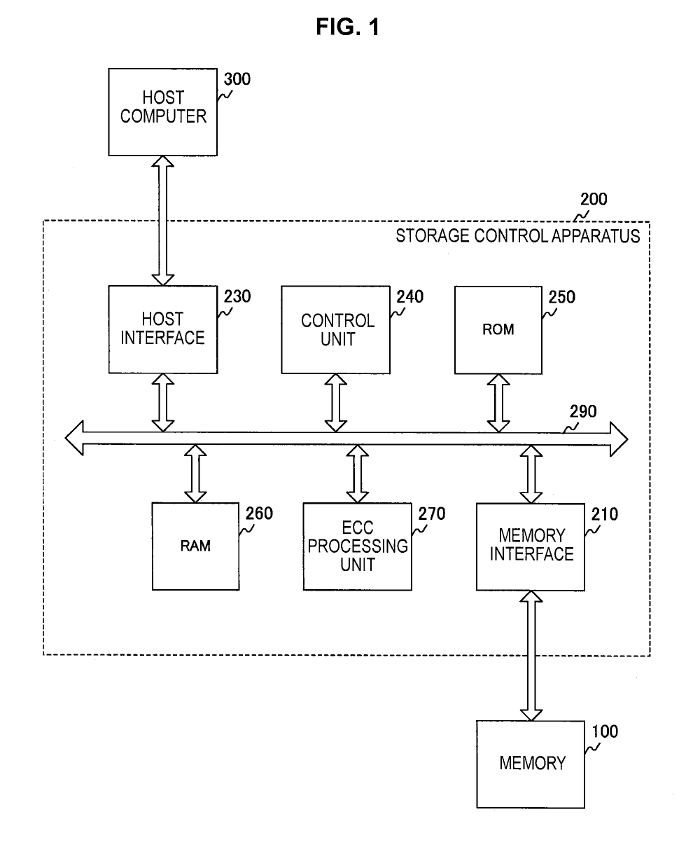

FIG. 1 is a diagram illustrating a configuration example of an information processing system according to an embodiment of the present disclosure. This information processing system includes a host computer 300, a storage control apparatus 200 and a memory 100. The host computer 300 denotes an apparatus that performs each processing in this information processing system, and denotes a computer to access the memory 100 by issuing a read command or write command to the memory 100. The memory 100 denotes a memory to temporarily store data requested for processing in the host computer 300. As this memory 100, there is assumed a nonvolatile memory, especially, a resistance-variation type memory (ReRAM) including a memory array formed with variable resistive elements. This memory 100 intends to improve a data retention characteristic by storing data together with an error correction code (ECC). The storage control apparatus 200 denotes an apparatus that connected between the host computer 300 and the memory 100, and controls the memory 100 according to a request from the host computer 300. Here, the error correction code includes an error (or fault) detection function and therefore may be referred to as “fault detection code,” “error detection code” or “error detection symbol.”

The storage control apparatus 200 includes a memory interface 210, a host interface 230, a control unit 240, a ROM 250, a RAM 260 and an ECC processing unit 270. These are mutually connected via a bus 290.

The memory interface 210 denotes an interface circuit to communicate with the memory 100. The host interface 230 denotes an interface circuit to communicate with the host computer 300.

The control unit 240 denotes a processing apparatus to perform various kinds of processing in the storage control apparatus 200. The ROM 250 denotes a read-only memory to record programs executed in the control unit 240 and parameters requested for the execution. The RAM 260 denotes a memory to store a work area requested for the processing in the control unit 240.

The ECC processing unit 270 denotes processing related to an error correction code stored in the memory 100. As described later, this ECC processing unit 270 includes a function of generating an error correction code and a function of performing error detection and error correction using data read out from the memory 100 and the error correction code.

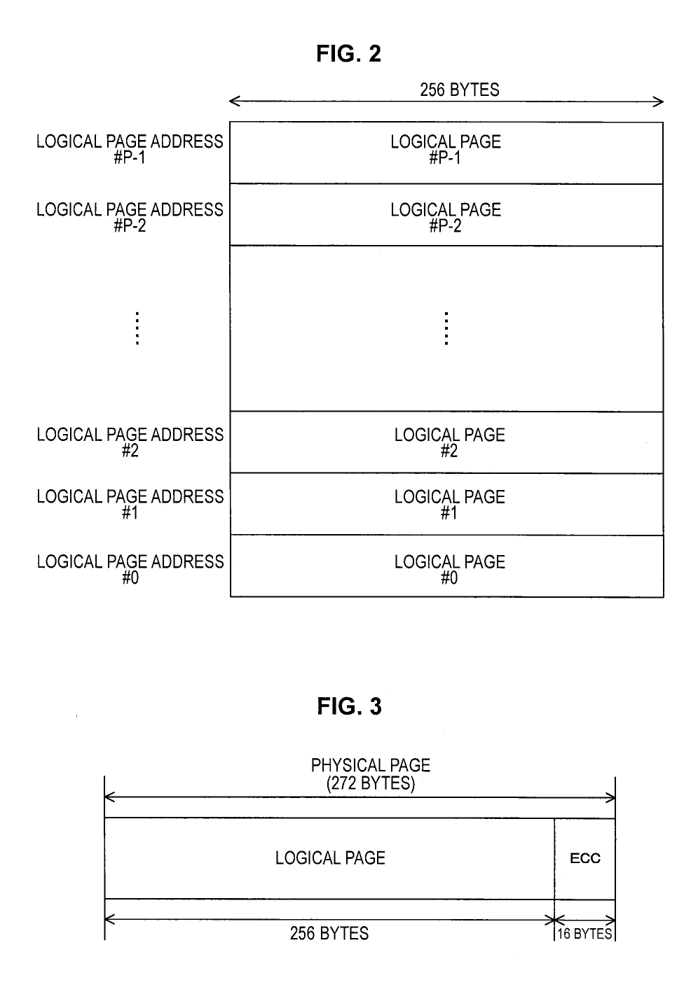

FIG. 2 is a diagram illustrating a management example of logical pages according to an embodiment of the present disclosure. An access space of the memory 100 is divided into fixed-length physical pages and managed. Each of the physical pages of the memory 100 is mapped on a logical page. Access from the host computer 300 is basically performed using a logical address. In the following, it is assumed that the data size of the logical page is 256 bytes.

By a write command, the address of a logical page of a write target and write data (256 bytes) to rewrite the whole of the designated logical page are supplied from the host computer 300 to the storage control apparatus 200. Also, by a read command, the address of a logical page of a read target is supplied from the host computer 300 to the storage control apparatus 200 and the whole of the logical page (256 bytes) read out from the memory 100 is collectively returned to the host computer 300.

FIG. 3 is a diagram illustrating a management example of a physical page according to an embodiment of the present disclosure. The physical page, to which an error correction code is attached, is stored. In the following, it is assumed that the physical page stores data of 256 bytes and an error correction code of 16 bytes. That is, the size of the physical page is 272 bytes. However, these sizes are just an example and the present disclosure is not limited to these.

### [Functional Configuration of Storage Control Apparatus]

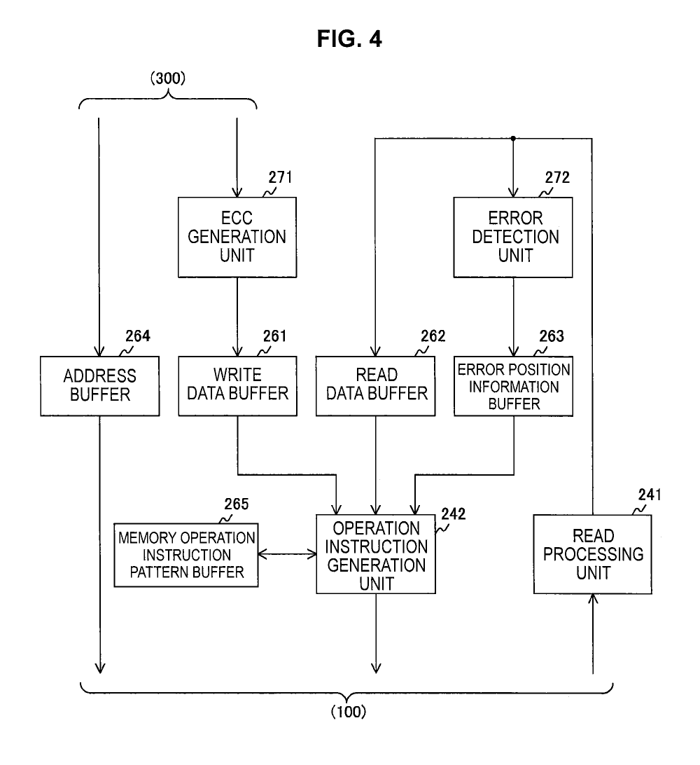

FIG. 4 is a diagram illustrating a functional configuration example of the storage control apparatus 200 according to an embodiment of the present disclosure. In the RAM 260 in this storage control apparatus 200, there are assigned areas of a write data buffer 261, read data buffer 262, error position information buffer 263, address buffer 264 and memory operation instruction pattern buffer 265. Also, this storage control apparatus 200 includes a read processing unit 241, an operation instruction generation unit 242, an ECC generation unit 271 and an error detection unit 272. The read processing unit 241 and the operation instruction generation unit 242 can be formed in the control unit 240. The ECC generation unit 271 and the error detection unit 272 can be formed in the ECC processing unit 270.

The write data buffer 261 denotes a buffer to hold write data and its error correction code (ECC). The read data buffer 262 denotes a buffer to hold read data and its ECC. The error position information buffer 263 denotes a buffer to hold a bit position of an error detected by error detection processing. The sizes of these three buffers are 272 bytes as described above.

The address buffer 264 denotes a buffer to hold an address of a write target or read target in the memory 100. The memory operation instruction pattern buffer 265 denotes a buffer to hold a memory operation instruction pattern to be described later.

The read processing unit 241 performs read processing with respect to the memory 100. This read processing unit 241 reads out data stored in a read target address as read data (and ECC) in response to a read command from the host computer 300. Also, this read processing unit 241 reads out data, which is already stored in a write target address, as pre-read data (and ECC), in response to a write command from the host computer 300. The data read out by this read processing unit 241 is held in the read data buffer 262. Here, the read processing unit 241 is an example of a read processing unit or memory state acquisition unit recited in the claims.

The ECC generation unit 271 generates an error correction code (ECC) associated with data. This ECC generation unit 271 generates an ECC with respect to write data designated by the host computer 300 and causes the write data buffer 261 to hold the ECC together with the write data.

The error detection unit 272 performs error detection processing of data based on an ECC. This error detection unit 272 performs error detection of read data based on the read data, which is read out from the memory 100 by the read processing unit 241, and an ECC thereof. A bit position of the error detected by this error detection unit 272 in the read data is held in the error position information buffer 263. Here, the error detection unit 272 is an example of an error detection unit or memory state acquisition unit recited in the claims.

The operation instruction generation unit 242 generates a memory operation instruction pattern based on the write data held in the write data buffer 261, the read data held in the read data buffer 262 and the error position information held in the error position information buffer 263. The memory operation instruction pattern generated by this operation instruction generation unit 242 is held in the memory operation instruction pattern buffer 265 or output to the memory 100. The memory operation instruction pattern for the memory 100 occupies at least 2 bits per cell (i.e. 1 bit) of the memory 100.

Here, the read data held in the read data buffer 262 and the error position information held in the error position information buffer 263 form a storage state of a memory related to the write target. Also, the memory operation instruction pattern forms an operation instruction.

### [Memory Configuration]

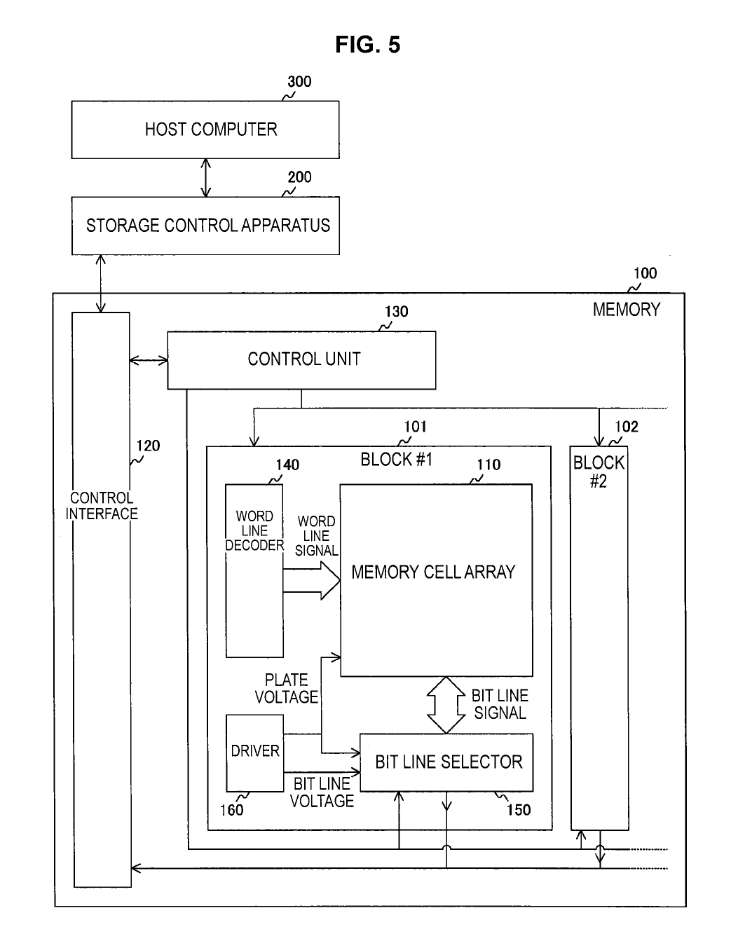

FIG. 5 is a diagram illustrating a configuration example of a memory 100 according to an embodiment of the present disclosure. The memory 100 includes a storage unit divided into multiple blocks 101, 102, and so on, a control interface 120 and a control unit 130. The control interface 120 denotes an interface to manage communication with the storage control apparatus 200. The control unit 130 controls access to each block. Here, the control interface 120 is an example of an operation instruction acquisition unit recited in the claims.

A block (e.g. block 101) of the storage unit includes a memory cell array 110, a word line decoder 140, a bit line selector 150 and a driver 160.

The memory cell array 110 includes access transistors and variable resistive elements in the intersection points of N word lines (WL) and M bit lines (BL). The word line is connected to the word line decoder 140. The bit line is connected to the bit line selector 150. A plate terminal is connected to a plate voltage output of the driver 160. In the following, an explanation is given with an assumption that the bit line number M is 2176 bits. When 2176 bits are divided by 8 bits corresponding to a byte unit, 272 is acquired. That is, the memory cell array 110 has a storage capacity of 272 bytes per word line and matches 272 bytes corresponding to the above physical page size.

A variable resistive element of the memory cell array 110 records information of one bit in two states of the high resistive state (HRS) and the low resistive state (LRS). An association between each state and a logical value is arbitrary, but, in the following, it is defined that a logical value “0” is expressed using the low resistive state and a logical value “1” is expressed using the high resistive state. Also, an operation of transition between two states is referred to as “bit inversion operation.” The bit inversion operation is formed with two operation types: a set operation and a reset operation. In the following, a bit in the high resistive state is shifted to the low resistive state by the set operation and a bit in the low resistive state is shifted to the high resistive state by the reset operation. That is, a bit of logical value “1” is shifted to logical value “0” by the set operation and a bit of logical value “0” is shifted to logical value “1” by the reset operation. In write processing, although the set operation and the reset operation are performed in order, it does not matter which of them is performed first. Here, which of two states of the low resistive state and the high resistive state is provided may be referred to as “polarity.”

The word line decoder 140 receives a word line designation from the control unit 130 and controls N word lines of the memory cell array 110. That is, the word line decoder 140 has a function of driving the word lines designated by the control unit 130 by logical value “H” and driving other word lines by logical value “L.” In a case where the word line designation is not performed or the word line designation is cancelled, the word line decoder 140 drives all word lines by logical value “L.”

The bit line selector 150 exchanges read data read out from the memory cell array 110 and write data to perform writing, between the control unit 130 and the control interface 120. Further, this bit line selector 150 receives a voltage to drive bit lines, from the driver 160.

This bit line selector 150 has two broadly classified functions. That is, the bit line selector 150 has a function as a sense amplifier at the time of reading in the memory cell array 110. To be more specific, by measuring the amount of current flowing in bit lines, the bit line selector 150 decides whether a selected variable resistive element is in the low resistive state or it is in the high resistive state, and determines logical value “0” or “1” with respect to each bit line. The determined logical value is output to the control unit 130 or the control interface 120.

Also, this bit line selector 150 has a function of selecting a drive voltage per bit line, based on the designation by the control unit 130, at the time of writing in the memory cell array 110. To be more specific, the bit line selector 150 selectively supplies one of a plate voltage and bit line voltage supplied from the driver 160, to each bit line.

The driver 160 denotes a driver to supply a bit line voltage to the bit line selector 150 and supply a plate voltage to the bit line selector 150 and the memory cell array 110. That is, this driver 160 supplies a drive voltage between a plate and a bit line.

### [Configuration of Memory Cell Array]

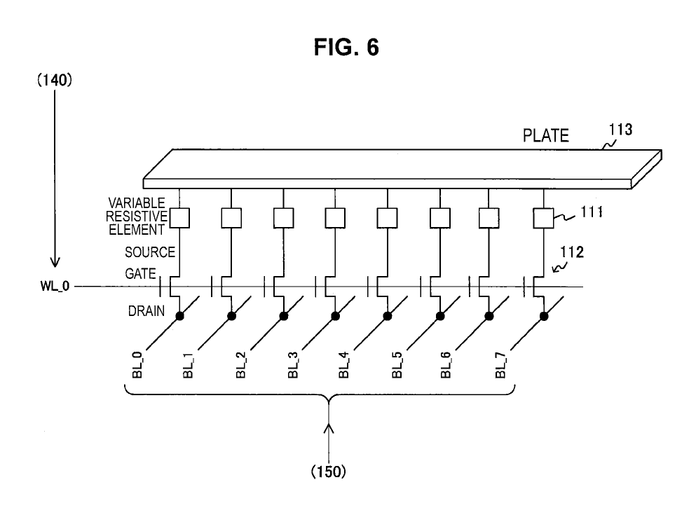

FIG. 6 is a diagram illustrating an example of a configuration of the memory cell array 110 according to an embodiment of the present disclosure. Although this figure schematically illustrates a cross-sectional surface along one word line WL_{—}0, other word lines have the same configuration. Here, only first eight bit lines BL_{—}0 to BL_{—}7 are illustrated. The intersection points of word line WL_{—}0 and eight bit lines (BL_{—}0 to BL_{—}7) are each connected to an FET (Field Effect Transistor) 112 as an access transistor and a variable resistive element 111.

Word line WL_{—}0 is connected to gate terminals of eight FET's 112, and eight bit lines (BL_{—}0 to BL_{—}7) are connected to the corresponding drain terminals of the FET's 112. The eight FET source terminals are connected to a plate 113 through the variable resistive elements 111. All (N×M in this case) of source terminals of the FET's 112 forming the memory cell array 110 in the same block are connected to the plate 113 through the corresponding variable resistive elements 111.

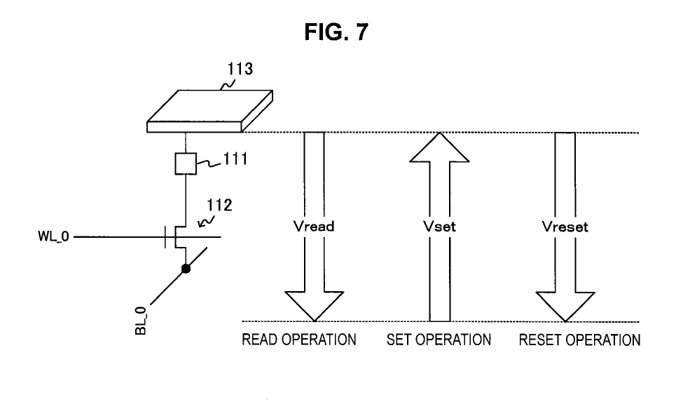

FIG. 7 is a diagram for explaining a drive voltage of the memory cell array 110 according to an embodiment of the present disclosure. As an operation with respect to the variable resistive element 111 of the memory cell array 110, there is a read operation of reading out a state of the variable resistive element 111, in addition to the above set operation and the reset operation. In these three operations, that is, in the read operation, the set operation and the reset operation, a drive voltage between the plate 113 and bit line BL_{—}0 is different.

In the case of the set operation, a voltage bias is set such that the plate 113 has a voltage of “+Vset” with respect to the bit line. In the case of the reset operation, a voltage bias is set such that the plate 113 has a voltage of “+Vreset” with respect to the bit line. Also, in the case of the read operation, a voltage bias is set such that the plate 113 has a voltage of “+Vread” with respect to the bit line.

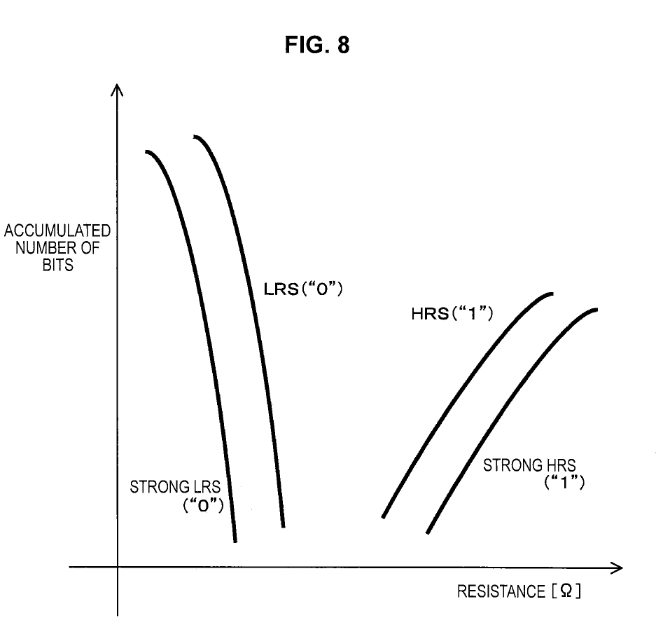

FIG. 8 is a diagram for explaining the polarity and intensity of a resistive state of the memory cell array 110 according to an embodiment of the present disclosure. As described above, a variable resistive element of the memory cell array 110 records information of one bit in two states of the high resistive state (HRS) and the low resistive state (LRS). In the figure, when the horizontal axis indicates a resistance value and the vertical axis indicates an accumulated number of bits, a part with a low resistance value and a part with a high resistance value are separated in the distribution. The part with a low resistance value indicates an LRS state and the part with a high resistance value indicates an HRS state.

In this variable resistive element, to enhance the data retention power, there is suggested a technique of performing writing using a higher pulse voltage or performing strong writing by applying a pulse after normal writing. That is, in the case of performing strong wiring at the time of shift to the LRS state, a resistive state lower than a normal LRS state (hereinafter referred to as “strong LRS state”) is provided. Also, in the case of performing strong writing at the time of shift to the HRS state, a resistive stat higher than a normal HRS state (hereinafter referred to as “strong HRS state”) is provided. According to such strong writing, the data retention power is enhanced by the writing, but, on the contrary, stress given to a memory cell increases, which reduces the durability. Here, which of the resistive state formed by normal writing and the resistive state formed by strong writing is provided may be referred to as “intensity.”

### [Memory Operation Instruction Pattern]

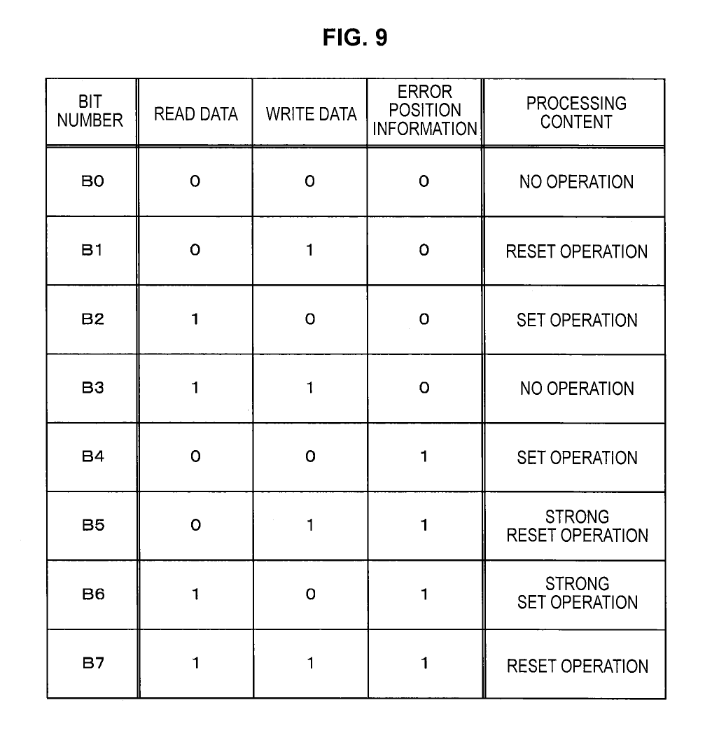

FIG. 9 is a diagram illustrating a relationship example of read data, write data, error position information and processing content in the memory 100 according to the first embodiment of the present disclosure. Here, eight combinations are illustrated as bit combinations of the read data, the write data and the error position information. In the following, it is presumed that these eight combinations are the first eight bits of the write data buffer 261, the read data buffer 262 and the error position information buffer 263, and an explanation is given by assigning bit numbers B0 to B7 in order. Here, although an explanation is given using only the first eight bits, actually, there are combinations for the number of bits (2176 bits in this example) of the write data buffer 261, the read data buffer 262 and the error position information buffer 263. Here, the read data denotes pre-read data acquired by reading out data that is already stored in a write target address.

Regarding bit numbers B0 to B3, since the value of the error position information is “0,” it shows that no error is detected. Therefore, by comparing the read data and the write data, requested operation content is determined. In the case of bit numbers B0 to B3, since the read data and the write data are equivalent, an operation is not requested. In the case of bit number B1, since it is requested to shift from “0” to “1,” a reset operation is performed. In the case of bit number B2, since it is requested to shift from “1” to “0,” a set operation is performed.

Regarding bit numbers B4 to B7, since the value of the error position information is “1,” it is a precondition that the read data contains an error. That is, it means that the cell has a weak retention power with respect to a specific value.

In the case of bit number B4, it is considered that a cell which is originally written as “1” changes to a state where it is read as “0” by variation with time. At the current time, a resistance value is the intermediate value between “1” and “0,” and it is considered that it is present near “0.” Therefore, by the set operation, it is shifted to a resistance value corresponding to “0.” Although it is considered that this memory cell has a weak retention power with respect to “1,” since it is not clear on this stage whether this memory cell has a strong retention power with respect “0” or it has a weak retention power with respect to “0,” a normal set operation is performed.

In the case of bit number B5, it is considered that a cell which is originally written as “1” changes to a state where it is read as “0” by variation with time. At the current time, a resistance value is the intermediate value between “1” and “0,” and it is considered that it is present near “0.” Therefore, by the reset operation, it is shifted to a resistance value corresponding to “1.” Also, since it is considered that this memory cell has a weak retention power with respect to “1,” a strong reset operation to perform an operation more strongly than a normal reset operation is performed.

In the case of bit number B6, it is considered that a cell which is originally written as “0” changes to a state where it is read as “1” by variation with time. At the current time, a resistance value is the intermediate value between “1” and “0,” and it is considered that it is present near “1.” Therefore, by the set operation, it is shifted to a resistance value corresponding to “0.” Also, since it is considered that this memory cell has a weak retention power with respect to “0,” a strong set operation to perform an operation more strongly than a normal set operation is performed.

In the case of bit number B7, it is considered that a cell which is originally written as “0” changes to a state where it is read as “1” by variation with time. At the current time, a resistance value is the intermediate value between “1” and “0,” and it is considered that it is present near “1.” Therefore, by the reset operation, it is shifted to a resistance value corresponding to “1.” Although it is considered that this memory cell has a weak retention power with respect to “0,” since it is not clear on this stage whether this memory cell has a strong retention power with respect “1” or it has a weak retention power with respect to “1,” a normal reset operation is performed.

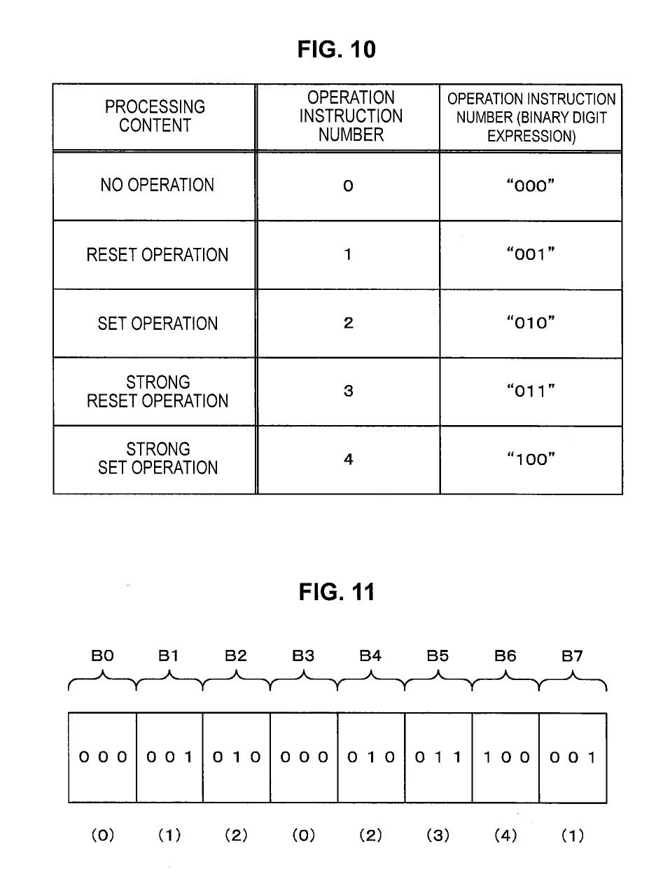

FIG. 10 is a diagram illustrating an example of operation instruction numbers according to the first embodiment of the present disclosure. In this example, in a case where an operation is not performed, “0” (“000”) is illustrated as an operation instruction number. In the case of performing a reset operation, “1” (“001”) is illustrated as an operation instruction number. In the case of performing a set operation, “2” (“010”) is illustrated as an operation instruction number. In the case of performing a strong reset operation, “3” (“011”) is illustrated as an operation instruction number. In the case of performing a strong set operation, “4” (“100”) is illustrated as an operation instruction number.

FIG. 11 is a diagram illustrating an example of a memory operation instruction pattern according to the first embodiment of the present disclosure. In this example, regarding above bit numbers B0 to B7, the operation instruction numbers arranged in order from the head by binary digit in units of 3 bits are used as a memory operation instruction pattern.

That is, with respect to bit number B0, “000” indicating no operation is provided. With respect to bit number B1, “001” indicating execution of a reset operation is provided. With respect to bit number B2, “010” indicating execution of a set operation is provided. With respect to bit number B3, “000” indicating no operation is provided. With respect to bit number B4, “010” indicating execution of a set operation is provided. With respect to bit number B5, “011” indicating execution of a strong reset operation is provided. With respect to bit number B6, “100” indicating execution of a strong set operation is provided. With respect to bit number B7, “001” indicating execution of a reset operation is provided.

Thus, in this example, as a memory operation instruction pattern, operation instructions of 24 bits with respect to 8 bits of bit numbers B0 to B7 are included. That is, an operation instruction of 3 bits per cell of the memory 100 is included. This memory operation instruction pattern is generated by the operation instruction generation unit 242 and output to the memory 100. Here, as described above, although an explanation is given using only the first eight bits, actually, a memory operation instruction pattern of 3 bits is generated with respect to the number of bits of the write data buffer 261, the read data buffer 262 or the error position information buffer 263. Therefore, in this example, the memory operation instruction pattern is 2176×3 bits.

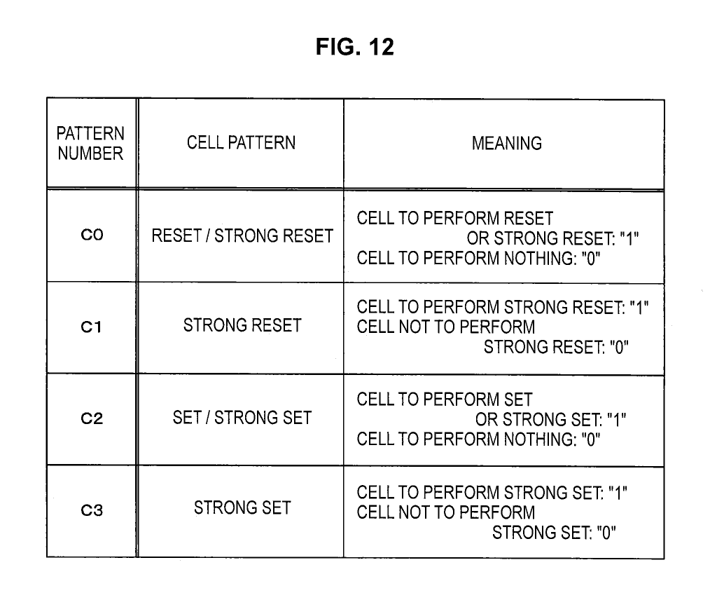

FIG. 12 is a diagram illustrating a cell pattern type example according to the first embodiment of the present disclosure. The memory 100 having received a memory operation instruction pattern of 3 bits from the storage control apparatus 200 generates a cell pattern of 4 bits in the control unit 130. This cell pattern denotes a control signal to perform control with respect to the memory cell array 110. Here, for each of explanation, the cell pattern number is assigned to each cell pattern.

Regarding cell pattern number C0, “1” is illustrated in a cell to perform a reset operation or strong reset operation and “0” is illustrated in a cell to perform none of them. Regarding cell pattern number C1, “1” is illustrated in a cell to perform a strong reset operation and “0” is illustrated in a cell not to perform the strong reset operation. Regarding cell pattern number C2, “1” is illustrated in a cell to perform a set operation or strong set operation and “0” is illustrated in a cell to perform none of them. Regarding cell pattern number C3, “1” is illustrated in a cell to perform a strong set operation and “0” is illustrated in a cell not to perform the strong set operation.

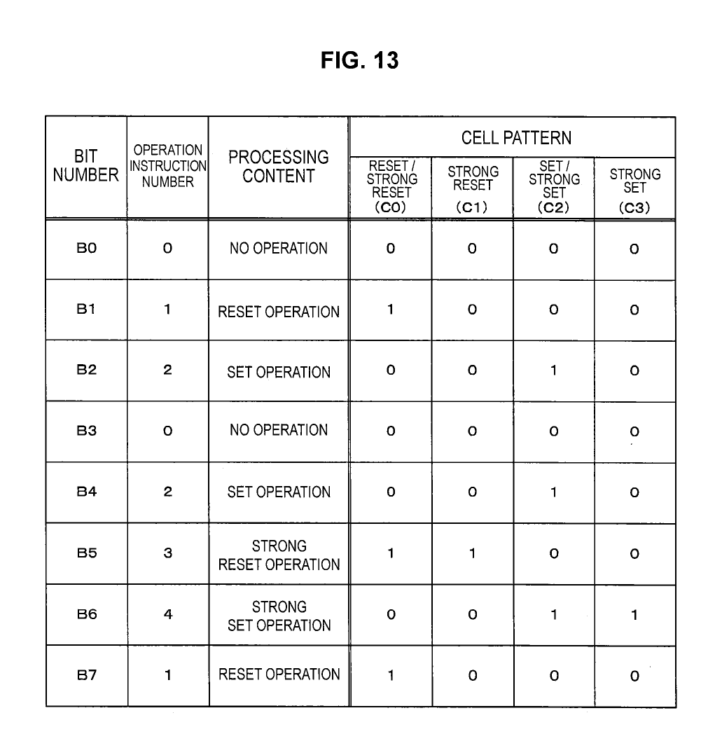

FIG. 13 is a diagram illustrating a specific example of cell patterns according to the first embodiment of the present disclosure. In this figure, an example is illustrated where cell patterns are generated for above bit numbers B0 to B7.

Regarding bit numbers B0 and B3, since no operation is performed, “0” is illustrated in all cell patterns. Regarding bit numbers B1 and B7, since a reset operation is performed instead of a strong reset operation, “1” is illustrated only in cell pattern number C0. Regarding bit numbers B2 and B4, since a set operation is performed instead of a strong set operation, “1” is illustrated only in cell pattern number C2. Regarding bit number B5, since a strong reset operation is performed, “1” is illustrated in cell pattern numbers C0 and C1. Regarding bit number B6, since a strong set operation is performed, “1” is illustrated in cell pattern numbers C2 and C3.

Scanning of memory operation instruction patterns to generate these cell patterns can be sequentially checked on a bit basis by using software, for example, and can be checked in parallel by using hardware.

In the memory 100, the control unit 130 performs an operation with respect to the memory cell array 110 using the cell patterns generated as above.

### [Operation of Information Processing System]

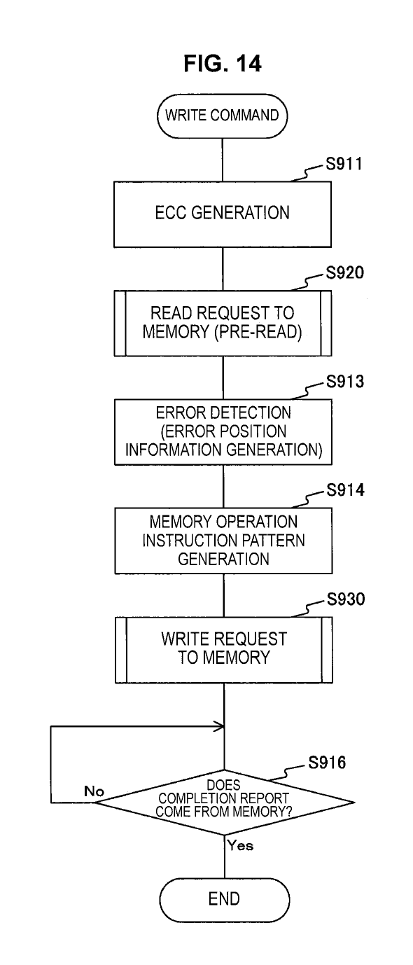

FIG. 14 is a flowchart illustrating a processing procedure example of operations with respect to a write command of the storage control apparatus 200 according to an embodiment of the present disclosure. When receiving a write command from the host computer 300, the storage control apparatus 200 performs processing along the following procedure.

The write command issued from the host computer 300 is input in the storage control apparatus 200 via the host interface 230. The write command includes the logical page address of a write target and write data. The write data size is the logical page size, specifically, 256 bytes. The write data in the write command is temporarily stored in the first 256 bytes of the write data buffer 261 of the RAM 260.

First, an ECC with respect to the write data designated by the host computer 300 is generated (step S911). To be more specific, the head address of the write data buffer 261 and a parity generation instruction are given to the ECC generation unit 271 of the ECC processing unit 270. The ECC generation unit 271 reads out the first 256 bytes of the write data buffer 261, generates an ECC of 16 bytes, writes it in the end 16 bytes of the write data buffer 261 and completes 272 bytes as a physical page image.

Data of a physical page corresponding to the logical page designated in the write command issued from the host computer 300 is read out (step S920). To be more specific, the storage control apparatus 200 gives a read request for a read instruction and the physical page address to the memory 100. At this time, a value designating the physical page address is the same as the value of the logical page address of the write target designated by the host computer 300. The memory 100 reads out content of a page corresponding to the designated physical page address and returns it to the storage control apparatus 200. The storage control apparatus 200 stores the physical page data transferred from the memory 100, in the read data buffer 262. Also, the read request processing in the memory 100 is described later in detail.

Subsequently, error detection is performed and error position information is established (step S913). To be more specific, the head address of the read data buffer 262 and an error position detection instruction are given to the error detection unit 272 of the ECC processing unit 270.

As described above, a physical page includes 256 bytes of data corresponding to a logical page and an ECC of 16 bytes. The error detection unit 272 performs a syndrome calculation and estimates an error position among so-called error correction processing, and causes the error position information buffer 263 to hold error position information in which a value of “1” is set to a bit of a position with a detected error and a value of “0” is set to bits of other positions. The size of the error position information is equal to the physical page size (272 bytes).

Here, correction processing on a detected error, that is, processing of inversing an error bit is not performed. Therefore, the read data buffer 262 still has data read out from the memory 100.

Next, a memory operation instruction pattern for the memory 100 is formed with respect to all bits (272 bytes×8 bytes) forming a physical page (step S914). In the above example, since a memory operation instruction pattern of 3 bits is formed with respect to data of one cell (one bit), 272 bytes×8 bits x 3 is provided in the whole physical page. A specific example of a memory operation instruction pattern is as described above in FIG. 9 to FIG. 11.

Subsequently, write processing is performed on the physical page corresponding to the logical page designated by the write command issued from the host computer 300 (step S930). To be more specific, the storage control apparatus 200 supplies a write request for a write instruction, a physical page address as the write target and a memory operation instruction pattern to the memory 100. Also, the write request processing in the memory 100 is described later in detail.

The storage control apparatus 200 waits for a completion report with respect to the write request from the memory 100, terminates a write operation after checking the completion report, and outputs a completion report to the host computer 300 (step S916). Here, error processing is omitted which supports a case where the completion report with respect to the write request does not arrive within the time limit or which supports a state where the write fails.

Also, in the above explanation, an operation with respect to a cell is determined taking into account write data and read data in addition to an error state of a write target page at the current time (i.e. a result of performing the read and error detection by ECC). In addition to this, it is possible to determine an operation with respect to a cell using an error state stored every page.

The storage control apparatus 200 may hold the page error state in an area inside the RAM 260. The page error state is read out from a specific area of the memory 100 at the time of activation of the storage control apparatus 200 and rewritten in the specific area of the memory 100 at the time of stop of the storage control apparatus 200. This page error state describes an error cell position per page and its state. In response to the write instruction from the host computer 300, it is possible to determine an operation per cell taking into account write data and read data in addition to an error history recorded in the page error state.

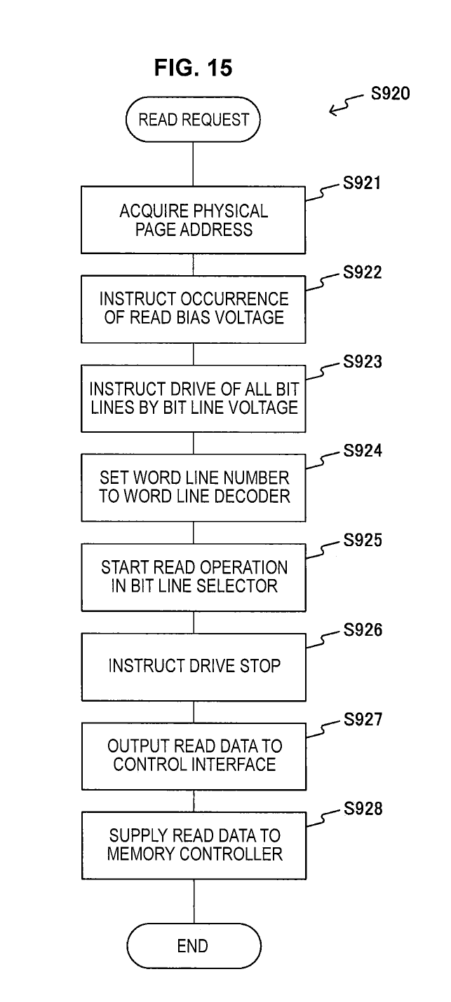

FIG. 15 is a flowchart illustrating a processing procedure example of operations with respect to a read request of the memory 100 according to an embodiment of the present disclosure. Here, this processing corresponds to an operation designated by the storage control apparatus 200 in step S920.

By a report from the control interface 120, the control unit 130 of the memory 100 knows that a request is received, and decides its command type. The control unit 130, which found that the received request is a read request, performs processing along the following procedure. Here, for ease of explanation, a value designated in a physical page address corresponding to an element of the read request is used as is as a word line number.

First, the control unit 130 acquires the physical page address corresponding to an element of the read request from the control interface 120 (step S921).

Subsequently, the control unit 130 instructs an occurrence of a voltage bias in a read operation to the driver 160 (step S922). To be more specific, it is set such that a bit line voltage is +Vread with respect to a plate voltage. By the plate voltage supplied from the driver 160, a plate of the memory cell array 110 is driven.

The control unit 130 instructs the bit line selector 150 to drive all bit lines by the bit line voltage (step S923). According to the instruction from the control unit 130, the bit line selector 150 supplies the bit line voltage, which is supplied from the driver 160, to all bit lines.

The control unit 130 sets the word line number designated by the read request (i.e. designated physical page address) to the word line decoder 140 (step S924). Subsequently, the bit line selector 150 is instructed to start a read operation (step S925).

The word line decoder 140 drives a word line corresponding to the designated word line, by logical value “H.” By this means, an access transistor connected to the corresponding word line gets in a conduction state and a voltage bias in the read operation caused in the driver 160 is applied to a ReRAM element. Subsequently, a current based on the high resistive state or low resistive state of each element flows in the bit line selector 150 through a bit line. By measuring the flowed current amount, the bit line selector 150 determines logic “0” or “1” corresponding to each ReRAM element. By this means, the logical state of the ReRAM element connected to the designated word line number is read out by the bit line selector 150.

The control unit 130 instructs the stop of the read operation with respect to the bit line selector 150 and cancels the setting of the word line number with respect to the word line decoder 140. Subsequently, it cancels the drive instruction of the bit lines with respect to the bit line selector 150 and instructs the stop of an occurrence of the voltage bias with respect to the driver 160 (step S926).

Also, although the timing of read completion may be determined by a clock held in the control unit 130 or determined by checking that a sufficient amount of current is maintained in the bit line selector 150, detailed explanation is omitted herein.

The control unit 130 instructs the data read out by the bit line selector 150 to be output to the control interface 120. Subsequently, the control unit 130 instructs the control interface 120 to supply the read data to the storage control apparatus 200 (step S928).

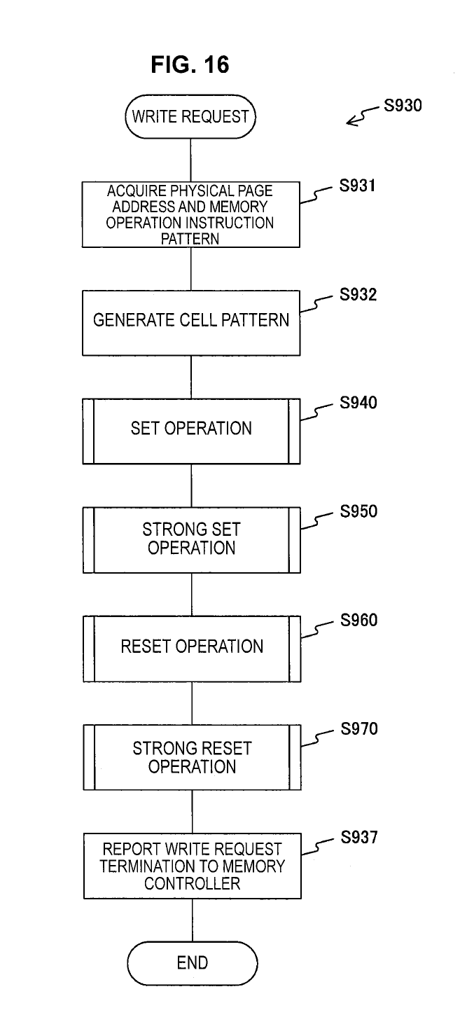

FIG. 16 is a flowchart illustrating a processing procedure example of operations with respect to a write request of the memory 100 according to an embodiment of the present disclosure. Here, this processing corresponds to the operation designated by the storage control apparatus 200 in step S930.

By a report from the control interface 120, the control unit 130 of the memory 100 knows that a request is received, and decides its command type. The control unit 130, which found that the received request is a write request, performs processing along the following procedure. Here, for ease of explanation, a value designated in a physical page address corresponding to an element of the write request is used as is as a word line number.

The control unit 130 acquires the physical page address corresponding to an element of the write request from the control interface 120 and a memory operation instruction pattern (step S931). Here, as a specific example of the memory operation instruction pattern, the above example of FIG. 11 is assumed. The control unit 130 recognizes the meaning of a numerical value of the memory operation instruction pattern. That is, the control unit 130 of the memory 100 also knows a correspondence table of memory operation instruction patterns encoded by the storage control apparatus 200. By using this correspondence table, the control unit 130 can interpret processing content for 2176 cells from memory operation instruction patterns of 6528 bits.

The control unit 130 generates a cell pattern from the memory operation instruction pattern (step S932). A specific example of cell patterns is as described in FIG. 13. As described above, four cell patterns are each formed with 2176 bits. This matches the cell number per word line.

Using the cell pattern generated as above, a set operation (step S940), a strong set operation (step S950), a reset operation (step S960) and a strong reset operation (step S970) are performed in order. When these operations are completed, the control unit 130 instructs the control interface 120 to report a termination of the write request to the storage control apparatus 200 (step S937).

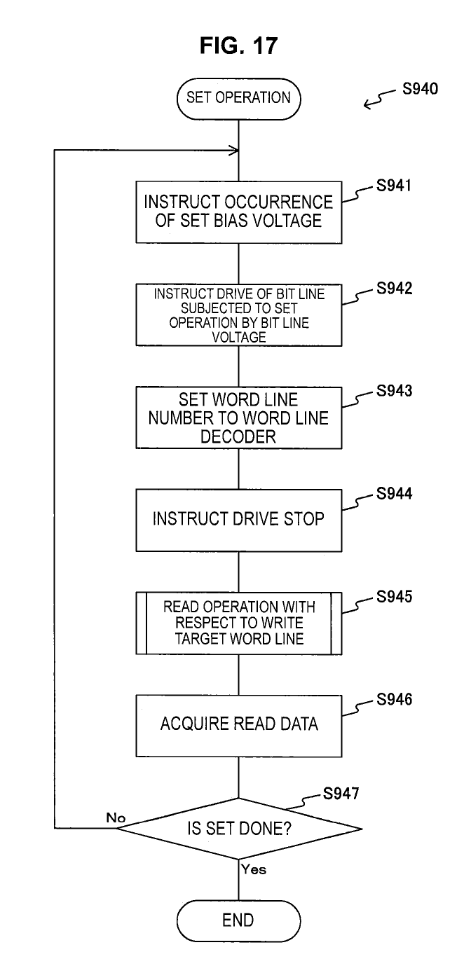

FIG. 17 is a flowchart illustrating a processing procedure example of the set operation (step S940) of the memory 100 according to an embodiment of the present disclosure.

The control unit 130 instructs an occurrence of a voltage bias in the set operation to the driver 160 (step S941). To be more specific, it is set such that a plate voltage is +Vset with respect to a bit line voltage. By the plate voltage supplied from the driver 160, a plate of the memory cell array 110 is driven.

The control unit 130 gives a cell pattern to perform a set operation to the bit line selector 150, and gives an instruction such that a bit line corresponding to value “1” is driven by the bit line voltage and a bit line corresponding to value “0” is driven by the plate voltage (step S942). The bit line selector 150 supplies the bit line voltage or plate voltage supplied from the driver 160, according to the instruction from the control unit 130.

The processing in steps S941 to S946 is repeated according to a decision result in S947. At this time, in a case where step S942 is performed for the first time, a cell pattern to perform the set operation is cell pattern number C2. In the case of performing step S942 for the second time or later, a pattern is used in which “1” is set to only bits for which the set operation is not found to be normally performed in S947.

A case is explained where step S942 is performed for the first time. Here, when the first eight cells of the write page is focused, since the first eight bits of cell pattern number C2 are “00101010,” only bit lines corresponding to bit numbers B2, B4 and B6 are driven by the bit line voltage. Subsequently, bit lines corresponding to other bit numbers B0, B1, B3, B5 and B7 are driven by the plate voltage.

The control unit 130 sets the word line number designated by the write request (i.e. designated physical page address) to the word line decoder 140 (step S943). The word line decoder 140 drives a word line corresponding to the designated word line, by logical value “H.” By this means, an access transistor connected to the corresponding word line gets in a conduction state.

At this time, a plate of the memory cell array 110 is driven by the plate voltage supplied from the driver 160, and the bit lines corresponding to bit numbers B2, B4 and B6 are driven by the bit line voltage according to the setting in step S942. Since this is a voltage bias requested for a set operation, the set operation is performed for ReRAM elements connected to the intersection points between the corresponding word line and the bit lines corresponding to bit numbers B2, B4 and B6.

Meanwhile, the bit lines corresponding to bit numbers B0, B1, B3, B5 and B7 are driven by the plate voltage according to the setting in step S942. Therefore, there occurs no voltage difference in both ends of a ReRAM element even if an access transistor gets in a conduction state, and a bit inversion operation is not performed.

The control unit 130 cancels the setting of the word line number with respect to the word line decoder 140, cancels the drive instruction of the bit lines with respect to the bit line selector 150 and instructs the stop of an occurrence of the voltage bias with respect to the driver 160 (step S944).

Here, it is considered that the timing of set operation completion is determined by a clock held in the control unit 130 or the like, but detailed explanation is omitted herein.

The control unit 130 performs processing in steps S922 to S926 in the read request operation in FIG. 15 and reads out a value recorded in a cell corresponding to a currently operated word line number (step S945). Subsequently, the control unit 130 accesses the bit line selector 150 and acquires the read data read out from the memory cell array 110 (step S946).

The control unit 130 compares the read data and cell pattern number C2 to check whether the set operation is normally performed (step S947). In a case where the set operation is normally performed (step S947: Yes), the set operation is terminated. Meanwhile, in a case where the set operation is not normally performed (step S947: No), the flow shifts to step S941 to perform the set operation again.

Also, in a second or subsequent set operation, only a bit for which the set operation is not found to be normally performed in S947 is targeted as a cell pattern to perform the set operation in step S942.

Also, to define the upper limit of the number of times the set operation is retried, although it is possible to employ a method of providing a counter to decide failures equal to or more than a defined number as errors, its explanation is omitted herein.

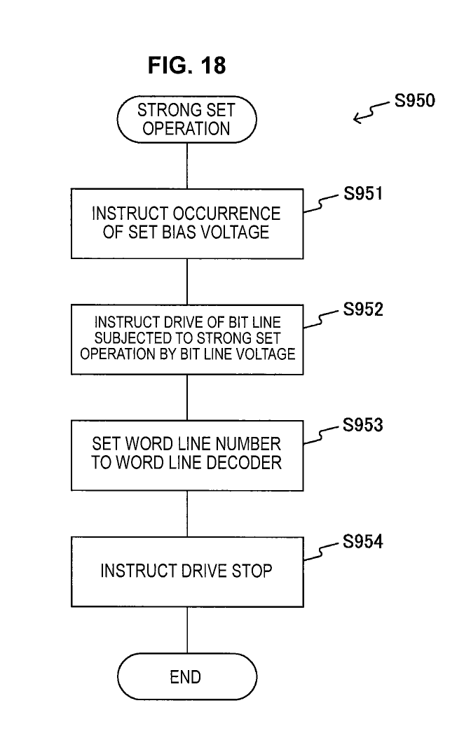

FIG. 18 is a flowchart illustrating a processing procedure example of the strong set operation (step S950) of the memory 100 according to an embodiment of the present disclosure. The strong set operation explained herein means to perform the same operations as in steps S941 to S944 in the set operation one more time, only on a cell designated by cell pattern number C3. In step S947, by additionally performing the set operation on a cell decided to be already set, the strong set operation is realized. Here, in addition to the method to perform the additional set operation, it is possible to employ a method of increasing an applied voltage or current and a method of lengthening the application time.

The control unit 130 instructs an occurrence of a voltage bias in the set operation to the driver 160 (step S951). To be more specific, it is set such that a plate voltage is +Vset with respect to a bit line voltage. By the plate voltage supplied from the driver 160, a plate of the memory cell array 110 is driven.

The control unit 130 gives a cell pattern (c3) to perform a strong set operation to the bit line selector 150, and gives an instruction such that a bit line corresponding to value “1” is driven by the bit line voltage and a bit line corresponding to value “0” is driven by the plate voltage (step S952). The bit line selector 150 supplies the bit line voltage or plate voltage supplied from the driver 160, according to the instruction from the control unit 130.

Here, when the first eight cells of the write page is focused, since the first eight bits of cell pattern number C3 are “00000010,” only a bit line corresponding to bit number B6 is driven by the bit line voltage. Subsequently, bit lines corresponding to the others (i.e. bit numbers B0 to B5 and B7) are driven by the plate voltage.

The control unit 130 sets the word line number designated by the write request (i.e. designated physical page address) to the word line decoder 140 (step S953). The word line decoder 140 drives a word line corresponding to the designated word line, by logical value “H.” By this means, an access transistor connected to the corresponding word line gets in a conduction state.

At this time, a plate of the memory cell array 110 is driven by the plate voltage supplied from the driver 160, and the bit line corresponding to bit number B6 is driven by the bit line voltage according to the setting in step S952. Since this is a voltage bias requested for a set operation, the set operation is performed for a ReRAM element connected to the intersection point between the corresponding word line and the bit line corresponding to bit number B6.

Meanwhile, the bit lines corresponding to bit numbers B0 to B5 and B7 are driven by the plate voltage according to the setting in step S952. Therefore, there occurs no voltage difference in both ends of the ReRAM element even if an access transistor gets in a conduction state, and a bit inversion operation is not performed.

The control unit 130 cancels the setting of the word line number with respect to the word line decoder 140, cancels the drive instruction of the bit lines with respect to the bit line selector 150 and instructs the stop of an occurrence of the voltage bias with respect to the driver 160 (step S954).

Here, it is considered that the timing of set operation completion is determined by a clock held in the control unit 130 or the like, but detailed explanation is omitted herein.

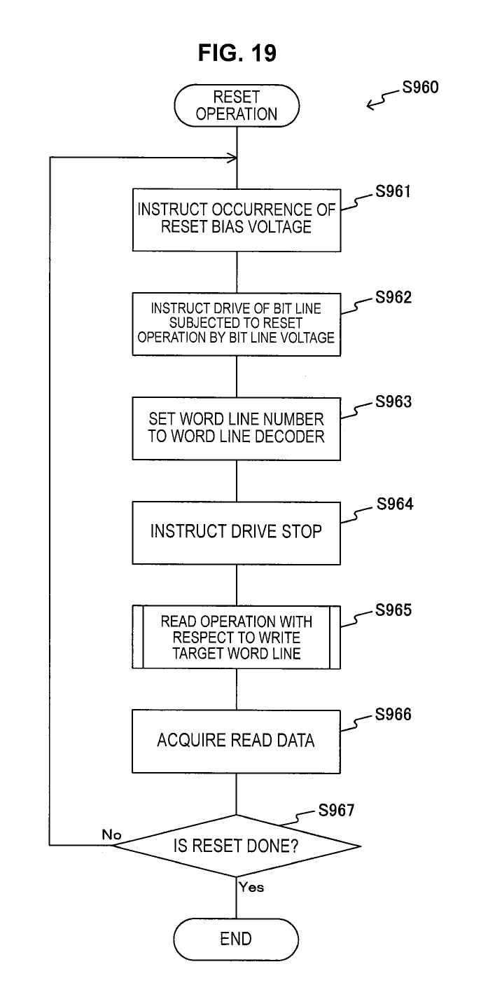

FIG. 19 is a flowchart illustrating a processing procedure example of the reset operation (step S960) of the memory 100 according to an embodiment of the present disclosure.

The control unit 130 instructs an occurrence of a voltage bias in the reset operation to the driver 160 (step S961). To be more specific, it is set such that a bit line voltage is +Vreset with respect to a plate voltage. By the plate voltage supplied from the driver 160, a plate of the memory cell array 110 is driven.

The control unit 130 gives a cell pattern to perform a reset operation to the bit line selector 150, and gives an instruction such that a bit line corresponding to value “1” is driven by the bit line voltage and a bit line corresponding to value “0” is driven by the plate voltage (step S962). The bit line selector 150 supplies the bit line voltage or plate voltage supplied from the driver 160, according to the instruction from the control unit 130.

The processing in steps S961 to S966 is repeated according to a decision result in S967. At this time, in a case where step S962 is performed for the first time, a cell pattern to perform the reset operation is cell pattern number C0. In the case of performing step S962 for the second time or later, a pattern is used in which “1” is set to only bits for which the reset operation is not found to be normally performed in S967.

A case is explained where step S962 is performed for the first time. Here, when the first eight cells of the write page is focused, since the first eight bits of cell pattern number C0 are “01000101,” only bit lines corresponding to bit numbers B1, B5 and B7 are driven by the bit line voltage. Subsequently, bit lines corresponding to other bit numbers B0, B2 to B4 and B6 are driven by the plate voltage.

The control unit 130 sets the word line number designated by the write request (i.e. designated physical page address) to the word line decoder 140 (step S963). The word line decoder 140 drives a word line corresponding to the designated word line, by logical value “H.” By this means, an access transistor connected to the corresponding word line gets in a conduction state.

At this time, a plate of the memory cell array 110 is driven by the plate voltage supplied from the driver 160, and the bit lines corresponding to bit numbers B1, B5 and B7 are driven by the bit line voltage according to the setting in step S962. Since this is a voltage bias requested for a reset operation, the set operation is performed for ReRAM elements connected to the intersection points between the corresponding word line and the bit lines corresponding to bit numbers B1, B5 and B7.

Meanwhile, the bit lines corresponding to bit numbers B0, B2 to B4 and B6 are driven by the plate voltage according to the setting in step S962. Therefore, there occurs no voltage difference in both ends of a ReRAM element even if an access transistor gets in a conduction state, and a bit inversion operation is not performed.

The control unit 130 cancels the setting of the word line number with respect to the word line decoder 140, cancels the drive instruction of the bit lines with respect to the bit line selector 150 and instructs the stop of an occurrence of the voltage bias with respect to the driver 160 (step S964).

Here, it is considered that the timing of reset operation completion is determined by a clock held in the control unit 130 or the like, but detailed explanation is omitted herein.

The control unit 130 performs processing in steps S922 to S926 in the read request operation in FIG. 15 and reads out a value recorded in a cell corresponding to a currently operated word line number (step S965). Subsequently, the control unit 130 accesses the bit line selector 150 and acquires the read data read out from the memory cell array 110 (step S966).

The control unit 130 compares the read data and cell pattern number C0 to check whether the reset operation is normally performed (step S967). In a case where the reset operation is normally performed (step S967: Yes), the reset operation is terminated. Meanwhile, in a case where the reset operation is not normally performed (step S967: No), the flow shifts to step S961 to perform the reset operation again.

Also, in a second or subsequent set operation, only a bit for which the reset operation is not found to be normally performed in S967 is targeted as a cell pattern to perform the reset operation in step S962.

Also, to define the upper limit of the number of times the reset operation is retried, although it is possible to employ a method of providing a counter to decide failures equal to or more than a defined number as errors, its explanation is omitted herein.

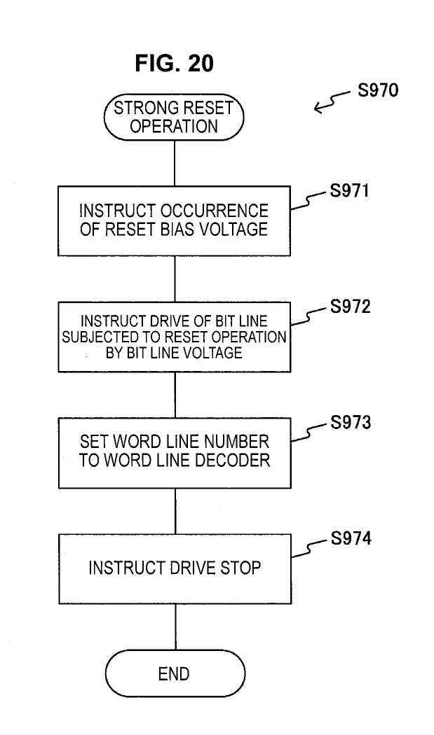

FIG. 20 is a flowchart illustrating a processing procedure example of the strong reset operation (step S970) of the memory 100 according to an embodiment of the present disclosure. The strong set operation explained herein means to perform the same operations as in steps S961 to S964 in the reset operation one more time, only on a cell designated by cell pattern number C1. In step S967, by additionally performing the reset operation on a cell decided to be already reset, the strong reset operation is realized. Here, in addition to the method to perform the additional reset operation, it is possible to employ a method of increasing an applied voltage or current and a method of lengthening the application time.

The control unit 130 instructs an occurrence of a voltage bias in the reset operation to the driver 160 (step S971). To be more specific, it is set such that a plate voltage is +Vreset with respect to a bit line voltage. By the plate voltage supplied from the driver 160, a plate of the memory cell array 110 is driven.

The control unit 130 gives a cell pattern (c1) to perform a strong reset operation to the bit line selector 150, and gives an instruction such that a bit line corresponding to value “1” is driven by the bit line voltage and a bit line corresponding to value “0” is driven by the plate voltage (step S972). The bit line selector 150 supplies the bit line voltage or plate voltage supplied from the driver 160, according to the instruction from the control unit 130.

Here, when the first eight cells of the write page is focused, since the first eight bits of cell pattern number C1 are “00000100,” only a bit line corresponding to bit number B5 is driven by the bit line voltage. Subsequently, bit lines corresponding to the others (B0 to B4, B6 and B7) are driven by the plate voltage.

The control unit 130 sets the word line number designated by the write request (i.e. designated physical page address) to the word line decoder 140 (step S973). The word line decoder 140 drives a word line corresponding to the designated word line, by logical value “H.” By this means, an access transistor connected to the corresponding word line gets in a conduction state.

At this time, a plate of the memory cell array 110 is driven by the plate voltage supplied from the driver 160, and the bit line corresponding to bit number B5 is driven by the bit line voltage according to the setting in step S972. Since this is a voltage bias requested for a reset operation, the set operation is performed for a ReRAM element connected to the intersection point between the corresponding word line and the bit line corresponding to bit number B5.

Meanwhile, the bit lines corresponding to bit numbers B0 to B4, B6 and B7 are driven by the plate voltage according to the setting in step S972. Therefore, there occurs no voltage difference in both ends of the ReRAM element even if an access transistor gets in a conduction state, and a bit inversion operation is not performed.

The control unit 130 cancels the setting of the word line number with respect to the word line decoder 140, cancels the drive instruction of the bit lines with respect to the bit line selector 150 and instructs the stop of an occurrence of the voltage bias with respect to the driver 160 (step S974).

Here, it is considered that the timing of reset operation completion is determined by a clock held in the control unit 130 or the like, but detailed explanation is omitted herein.

Thus, according to the first embodiment of the present disclosure, by setting 3 bits to an information amount of a memory operation instruction patter per bit from the storage control apparatus 200 to the memory 100, it is possible to perform adaptive control with respect to the memory 100.

### 2. Second Embodiment

In the above embodiment, an operation instruction number of 3 bits is equally assigned to each processing content. In the research and development of a ReRAM device, efforts have been made to reduce the rate of cells requesting a strong set operation or strong reset operation because of a small retention power. Also, a page with a large rate of cells requesting the strong set operation or strong reset operation may be regarded to have low reliability and may be replaced with a substitute page. In this case, when it is considered within a range of pages that are actually used, it is expected to reduce the rate of cells requesting the strong set operation or strong reset operation.

Therefore, in this second embodiment, it is assumed that the occurrence frequency of strong writing is relatively low, and the code assigned to each processing content is extendable. Also, a basic configuration as an information processing system is similar to the first embodiment and therefore specific explanation of the configuration is explained.

### [Memory Operation Instruction Pattern]

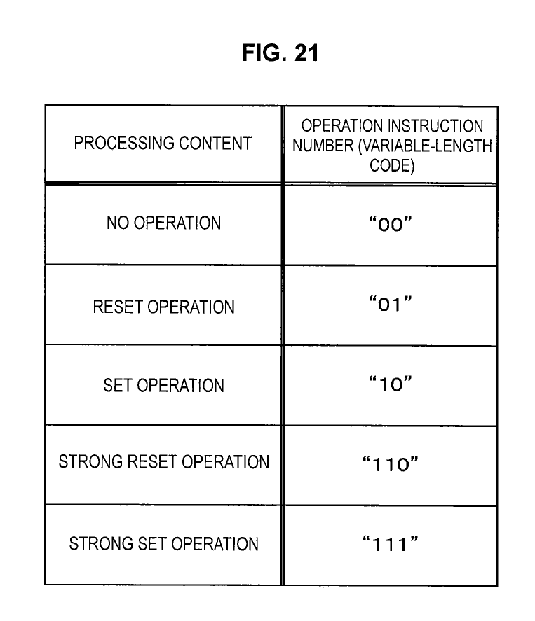

FIG. 21 is a diagram illustrating an assignment example of operation instruction numbers according to the second embodiment of the present disclosure. In this example, it is premised that the occurrence frequency of strong writing is relatively low, and a code of 3 bits is assigned to an operation of strong writing and a code of 2 bits is assigned to other operations, that is, variable-length codes are assigned.

In this example, in the case of no operation, “00” is assigned as an operation instruction number code. In the case of performing a reset operation, “01” is assigned as an operation instruction number code. In the case of performing a set operation, “10” is assigned as an operation instruction number code. In the case of performing a strong reset operation, “110” is assigned as an operation instruction number code. In the case of performing a strong set operation, “111” is assigned as an operation instruction number code.

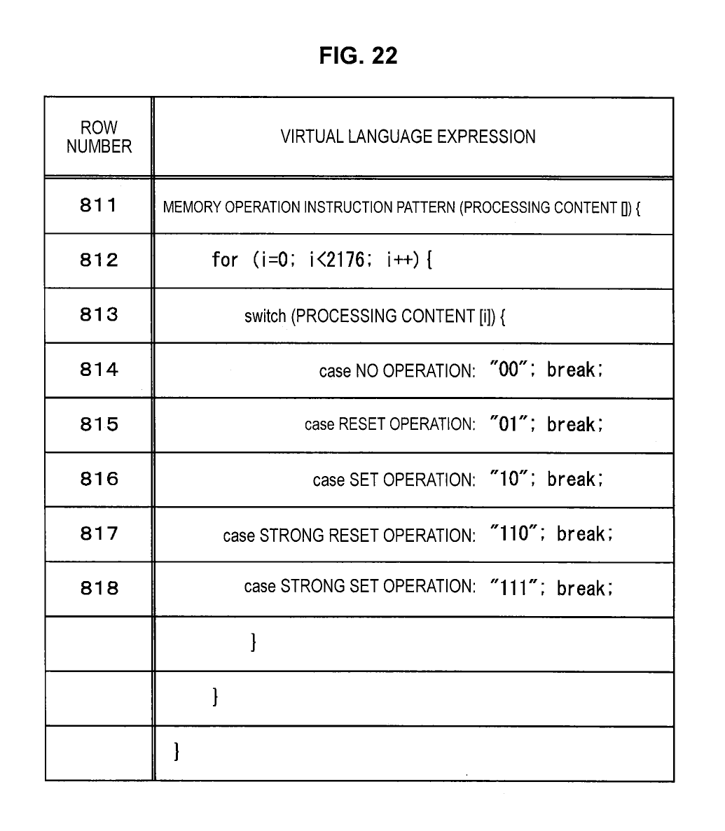

FIG. 22 is a diagram illustrating a definition example using virtual language expression of operation instruction numbers according to the second embodiment of the present disclosure.

Row 811 declares the start of definition. Here, “processing content [ ]” given as a parameter of “memory operation instruction pattern” is an array of 2176 elements. By the “for” statement in row 812, loop processing with respect to 2176 cells is controlled. By the “switch” statement in row 813, processing content with respect to cells is sorted. By the “case” statements in rows 814 to 818, the length corresponding to each cell operation content and a pattern code are output.

The control interface 120 of the memory 100 having received a “memory operation instruction pattern” subjected to variable-length coding as above decodes the variable-length code as follows. That is, the control interface 120 acquires the first two bits of the “memory operation instruction pattern.” At this time, a value of “0” is output in the case of “00,” a value of “1” is output in the case of “01” and a value of “2” is output in the case of “10.” In a case where the first two bits are “11,” the first one bit of the “memory operation instruction pattern” is further acquired, and “3” is output in a case where the one bit which is additionally read out is “0,” and “4” is output in a case where the one bit which is additionally read out is “1.”

Here, although a software algorithm has been illustrated, it is possible to use a decoding method of variable-length codes using a barrel shifter.

Thus, according to the second embodiment of the present disclosure, by assigning a variable-length code to a memory operation instruction pattern, it is possible to reduce the size of the memory operation instruction pattern.

### 3. Third Embodiment

In the above embodiments, an example has been illustrated on the premise that operations with respect to a cell are limited to five types including “no operation.” However, there are various options such as a voltage and time, as parameters related to a cell operation of ReRAM. However, the rate of cells requesting the use of specific parameters is low. Therefore, there is a method of collectively describing information related to cells subject to specific operations in the last half of a memory operation instruction pattern.

That is, the anterior half of the memory operation instruction pattern expresses states with respect to all cells by data of 2176 cells×2 bits. Also, the last half describes position information of cells with “other operations” and information indicating the operations in detail.

### [Memory Operation Instruction Pattern]

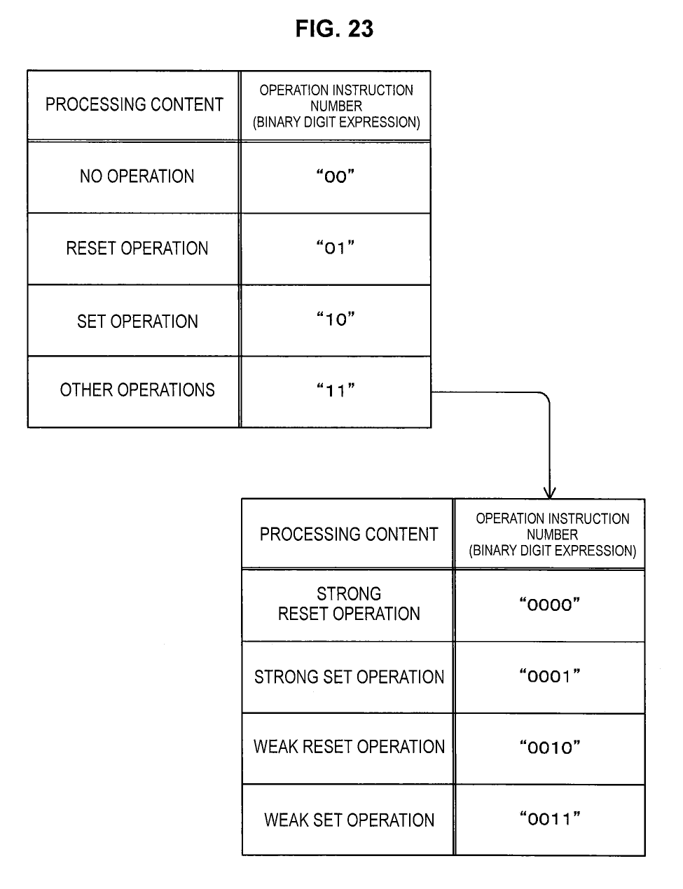

FIG. 23 is a diagram illustrating an assignment example of operation instruction numbers according to the third embodiment of the present disclosure. In this example, “00,” “01” and “10,” which are formed with 2 bits, are assigned to “no operation,” “reset operation” and “set operation.” Further, “11” is assigned to a cell to perform “other operations.”

Also, in the case of “other operations,” furthermore, one of multiple options is designated. That is, “0000” is assigned in the case of “strong reset operation,” “0001” is assigned in the case of “strong set operation,” “0010” is assigned in the case of “weak reset operation” and “0011” is assigned in the case of “weak set operation.”

Here, the weak reset operation and the weak set operation mean to perform weak writing, by contrast with the strong writing explained in FIG. 8. That is, in the case of performing writing using a low pulse voltage when it is shifted to an LRS state, it gets in a resistive state higher than a normal LRS state (hereinafter referred to as “weak LRS”). Also, in the case of performing writing using a low pulse voltage when it is shifted to an HRS state, it gets in a resistive state lower than a normal HRS state (hereinafter referred to as “weak HRS”).

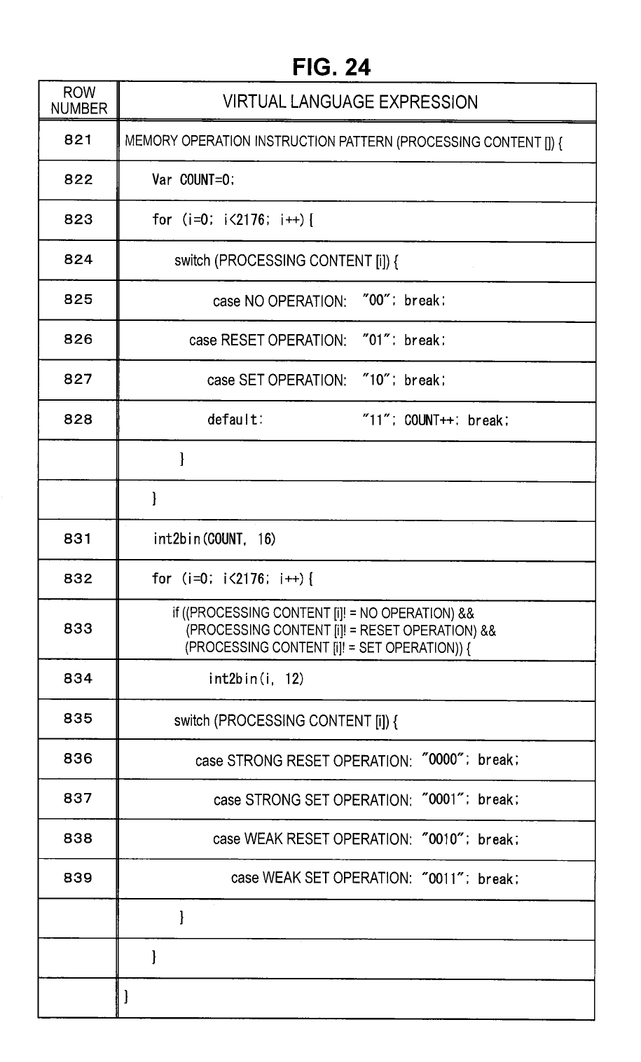

FIG. 24 is a diagram illustrating a definition example using virtual language expression of operation instruction numbers according to the third embodiment of the present disclosure.

Row 821 declares the start of definition. Here, “processing content [ ]” given as a parameter of “memory operation instruction pattern” is an array of 2176 elements. In row 822, internal variable COUNT is declared and initialization is performed by value “0.” By the “for” statement in row 823, first loop processing with respect to 2176 cells is controlled. By the “switch” statement in row 824, processing content with respect to cells is sorted. By the “case” statement in rows 825 to 827, codes with respect to three cases of no operation, the reset operation and the set operation are output. By the “default” statement in row 828, code “11” with respect to operations in other cases than the three cases is output. Also, internal variable COUNT is incremented.

By the above first loop, first information with respect to 2176 cells is output. Internal variable COUNT indicates the number of cells of “strong rest operation,” “strong set operation,” “weak reset operation” and “weak set operation” among 2176 cells.

In row 831, the value of internal variable COUNT is output. Here, function int2bin( ) denotes a function to output the value of a first parameter as the number of bits of a second parameter. In this example, the value of internal variable COUNT is output by the binary digit of 16 bits. By the “for” statement in row 832, second loop processing with respect to 2176 cells is controlled. By the “if” statement in row 833, information is output in rows 834 to 839 in other cases than the cases of no operation, the reset operation and the set operation. In row 834, a cell position is output by the binary digit of 12 bits. In row 835, by the “switch” statement, processing content with respect to cells is sorted. By the “case” statement in rows 836 to 839, a code with respect to the strong reset operation, strong set operation, weak reset operation or weak set operation is output.

Thus, according to the third embodiment of the present disclosure, by collecting other operations in the last half of a memory operation instruction pattern, it is possible to separate exceptional processing and perform management.

### 4. Fourth Embodiment

In the above embodiments, an example has been explained using a device to realize a strong operation by performing a set operation again after performing a normal set operation. However, depending on a device, a case may occur where the device is destroyed by continuous set operations or continuous reset operations. In the case of using such a device, it is possible to apply the following decision and instruction.

### [Memory Operation Instruction Pattern]

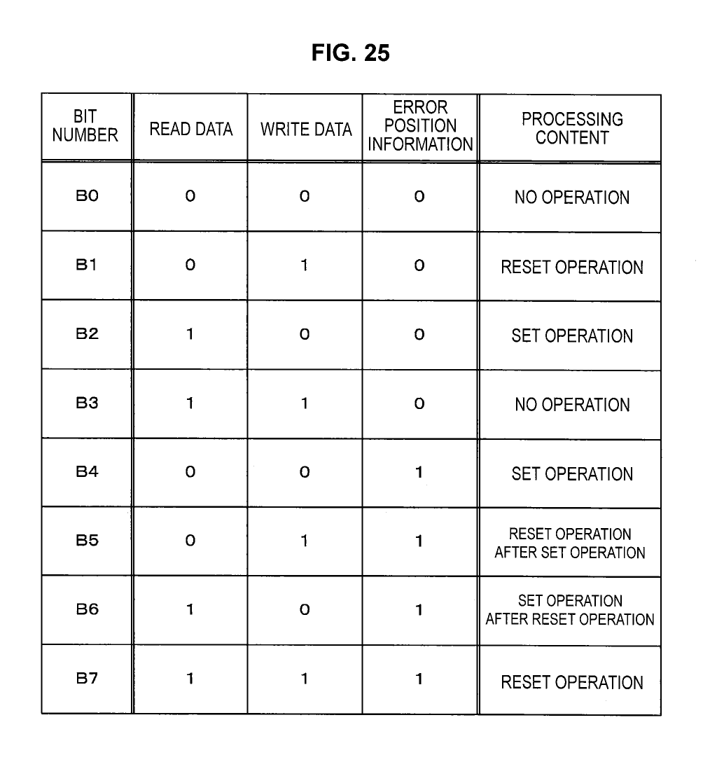

FIG. 25 is a diagram illustrating a relationship example of read data, write data, error position information and processing content in the memory 100 according to the fourth embodiment of the present disclosure. When this example and the above explanation in FIG. 9 are compared, they are different in processing content in bit numbers B5 and B6. Regarding other bit numbers B0 to B4 and B7, since they are the same as explained in FIG. 9, their explanation is omitted.

In the case of bit number B5, it is considered that a cell which is originally written as “1” changes to a state where it is read as “0” by variation with time, but, when a reset operation is continuously performed to set this cell to “1,” a device quality problem may be caused. Therefore, by shifting it to a resistance value corresponding to “0” by a set operation once and then shifting it to a resistance value corresponding to “1” by a reset operation, consecutive reset operations with respect to the same cell are avoided.

In the case of bit number B6, it is considered that a cell which is originally written as “0” changes to a state where it is read as “1” by variation with time, but, when a set operation is continuously performed to set this cell to “0,” a device quality problem may be caused. Therefore, by shifting it to a resistance value corresponding to “1” by a reset operation once and then shifting it to a resistance value corresponding to “0” by a set operation, consecutive set operations with respect to the same cell are avoided.

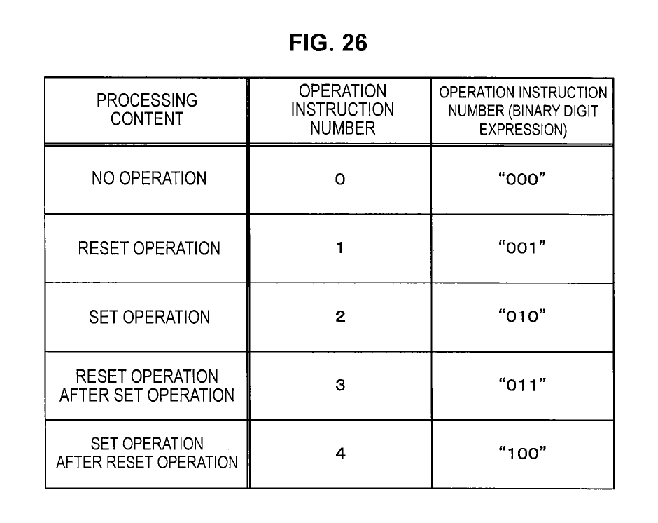

FIG. 26 is a diagram illustrating an example of operation instruction numbers according to the fourth embodiment of the present disclosure. In this example, in the case of no operation, “0” (“000”) is illustrated as an operation instruction number. In the case of performing a reset operation, “1” (“001”) is illustrated as an operation instruction number. In the case of performing a set operation, “2” (“010”) is illustrated as an operation instruction number. In the case of performing the reset operation after the set operation, “3” (“011”) is illustrated as an operation instruction number. In the case of performing the set operation after the reset operation, “4” (“100”) is illustrated as an operation instruction number.

Thus, according to the fourth embodiment of the present disclosure, even for the memory 100 using a device for which it is not adequate to continuously perform the set operation or the reset operation, it is possible to perform adaptive control by a memory operation instruction pattern.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)
A storage control apparatus including:

a memory state acquisition unit acquiring a storage state of a memory associated with a write target; and

an operation instruction generation unit generating an operation instruction of at least 2 bits per cell of the memory associated with the write target, from the acquired storage state and write data.

(2)
The storage control apparatus according to (1),

wherein the memory state acquisition unit includes

a read processing unit reading out data stored in the memory associated with the write target, as read data, and

an error detection unit performing an error detection of the read data and generating error position information indicating a position in which an error is detected, and

wherein the memory state acquisition unit acquires the read data and the error position information as the storage state.

(3)
The storage control apparatus according to (1) or (2), wherein the operation instruction includes an instruction related to a combination of a polarity and intensity of writing in the memory associated with the write target.
(4)
The storage control apparatus according to (3), wherein, in a case where the memory is a variable resistive element, the polarity of the writing is in one of a high resistive state and a low resistive state, which are decided by a predetermined threshold value in the variable resistive element, and the intensity of the writing is an intensity of a resistive state in the variable resistive element.
(5)
The storage control apparatus according to any one of (1) to (4), wherein the operation instruction includes an instruction related to two writings of different polarities in the memory associated with the write target.
(6)
The storage control apparatus according to any one of (1) to (5), wherein the operation instruction generation unit encodes the operation instruction by a variable-length code.
(7)
A storage apparatus including:

a memory including a plurality of memory cells;

an operation instruction acquisition unit acquiring an operation instruction of at least 2 bits per cell of the memory cell associated with a write target; and

a control unit performing write processing on the memory cell associated with the write target according to the operation instruction.

(8)
A storage apparatus including:

a memory including a plurality of memory cells;

a memory state acquisition unit acquiring a storage state of the memory cell associated with a write target;

an operation instruction generation unit generating an operation instruction of at least 2 bits per cell of the memory cell associated with the write target, from the acquired storage state and write data; and

a control unit performing write processing on the memory cell associated with the write target according to the operation instruction.

(9)
A storage control method including:

a memory state acquisition operation acquiring a storage state of a memory associated with a write target; and

an operation instruction generation operation generating an operation instruction of at least 2 bits per cell of the memory associated with the write target, from the acquired storage state and write data.

The present disclosure contains subject matter related to that disclosed in Japanese Priority Patent Application JP 2012-159688 filed in the Japan Patent Office on Jul. 18, 2012, the entire content of which is hereby incorporated by reference.

What is claimed is:

1. A storage control apparatus comprising:
a memory state acquisition unit acquiring a storage state of a memory associated with a write target; and
an operation instruction generation unit generating an operation instruction of at least 2 bits per cell of the memory associated with the write target, from the acquired storage state and write data.

2. The storage control apparatus according to claim 1,
wherein the memory state acquisition unit includes
a read processing unit reading out data stored in the memory associated with the write target, as read data, and
an error detection unit performing an error detection of the read data and generating error position information indicating a position in which an error is detected, and
wherein the memory state acquisition unit acquires the read data and the error position information as the storage state.

3. The storage control apparatus according to claim 1, wherein the operation instruction includes an instruction related to a combination of a polarity and intensity of writing in the memory associated with the write target.

4. The storage control apparatus according to claim 3, wherein, in a case where the memory is a variable resistive element, the polarity of the writing is in one of a high resistive state and a low resistive state, which are decided by a predetermined threshold value in the variable resistive element, and the intensity of the writing is an intensity of a resistive state in the variable resistive element.

5. The storage control apparatus according to claim 1, wherein the operation instruction includes an instruction related to two writings of different polarities in the memory associated with the write target.

6. The storage control apparatus according to claim 1, wherein the operation instruction generation unit encodes the operation instruction by a variable-length code.

7. A storage apparatus comprising:
a memory including a plurality of memory cells;
an operation instruction acquisition unit acquiring an operation instruction of at least 2 bits per cell of the memory cell associated with a write target; and
a control unit performing write processing on the memory cell associated with the write target according to the operation instruction.

8. A storage apparatus comprising:
a memory including a plurality of memory cells;
a memory state acquisition unit acquiring a storage state of the memory cell associated with a write target;
an operation instruction generation unit generating an operation instruction of at least 2 bits per cell of the memory cell associated with the write target, from the acquired storage state and write data; and
a control unit performing write processing on the memory cell associated with the write target according to the operation instruction.

9. A storage control method comprising:
a memory state acquisition operation acquiring a storage state of a memory associated with a write target; and
an operation instruction generation operation generating an operation instruction of at least 2 bits per cell of the memory associated with the write target, from the acquired storage state and write data.
